(19) United States
(12) Patent Application Publication
(10) Pub. No.: US 2025/0086573 A1
(43) Pub. Date: Mar. 13, 2025

(54) Modern Milk Truck and A Method of Using a Product Transport and Storage System for Delivering Containers and Packages

(71) Applicant: David M. Candelario, James Island, SC (US)

(72) Inventor: David M. Candelario, James Island, SC (US)

(21) Appl. No.: 18/957,247

(22) Filed: Nov. 22, 2024

Related U.S. Application Data
(63) Continuation-in-part of application No. 17/595,985, filed on Dec. 1, 2021.

(51) Int. Cl. G06Q 10/0833; B60P 1/54; B60P 3/00; F16F 15/02; G06Q 10/083

(52) U.S. Cl. CPC G06Q 10/0833; B60P 1/5442; B60P 3/007; F16F 15/02; G06Q 10/0838

(57) ABSTRACT

This invention relates to an advanced product transport and delivery system utilizing a combination of automated bots and a specialized delivery vehicle, the Modern Milk Truck (MMT). The system automates the entire delivery process, from order receipt to final delivery, through the integration of porch bots, railed crane bots, railed fork bots, and mother bots. These components work in tandem to ensure efficient loading, transport, and precise placement of products at the delivery location. The MMT features hybrid power, advanced environmental controls, and autonomous driving capabilities, enhancing the reliability and sustainability of deliveries. AI-based optimization dynamically adjusts routes and delivery sequences in real-time, improving efficiency and reducing operational costs. The invention provides real-time tracking and environmental monitoring, ensuring product integrity and improving customer satisfaction. This system significantly advances the efficiency, safety, and reliability of modern delivery operations.

### CROSS-REFERENCE TO RELATED APPLICATIONS

In compliance with 35 U.S.C. 102(b)(2)(C) and the requirements set forth in the Manual of Patent Examining Procedure (MPEP), this statement is to establish that the subject matter disclosed in the Provisional Application No. 63/198,686 (188DMC-P0001), PCT Application No. PCT/US21/70626 (188DMC-P0003), 371 application Ser. No. 17/595,985 (188DMC-P0004), PCT Application No. PCT/US22/74828 (188DMC-P0005), and PCT Application No. PCT/US24/12319 (188DMC-P0006) is not prior art to the claimed invention in the present application. This is because the disclosed subject matter and the claimed invention were, not later than the effective filing date of the claimed invention, owned by the same person or subject to an obligation of assignment to the same person.

I, Gregory D Carson, as the patent attorney of record for David M. Candelario, hereby declare that the subject matter disclosed in the above referenced applications and the claimed invention in the present application were, not later than the effective filing date of the claimed invention in the present application, owned by David M. Candelario.

### BACKGROUND OF THE INVENTION

### Technical Field

This invention relates generally to a product transport and storage system designed for efficient and automated delivery of goods. This invention relates more particularly to an apparatus/device for facilitating the transportation, storage, and delivery of products through the use of automated bots, such as porch bots, railed crane bots, railed fork bots, and mother bots, in conjunction with a specialized vehicle known as the Modern Milk Truck (MMT). The system is engineered to enhance the accuracy, speed, and reliability of product deliveries, integrating advanced technologies such as AI-based optimization, real-time tracking, and environmental controls.

This invention relates generally to apparatuses and devices for automating and optimizing the process of product transport and delivery, with a particular focus on the integration of robotic systems and specialized delivery vehicles. This method also can be used with various delivery systems that require precise handling, storage, and transportation of goods, especially in environments where efficiency and accuracy are paramount. This invention relates more particularly to a comprehensive system designed to improve the overall delivery process, from order receipt to final delivery, by utilizing a combination of advanced robotics, machine learning, and autonomous vehicle technologies to reduce delivery times, enhance safety, and ensure the integrity of the delivered products.

### Background Art

The field of product transport and delivery has seen various advancements over the years, with numerous innovations aimed at improving the efficiency, speed, and reliability of the delivery process. However, despite these advancements, several challenges remain unaddressed by the existing technologies, leading to inefficiencies and limitations that impact both businesses and consumers.

### Traditional Delivery Systems:

Manual Labor Dependency: Traditional delivery systems rely heavily on manual labor for tasks such as product selection, packing, loading, and delivery. Workers manually pick items from shelves, pack them into boxes, and load them onto delivery vehicles. This process is time-consuming and labor-intensive, leading to higher operational costs and potential delays, especially during peak periods. The dependence on manual labor also increases the likelihood of human error, such as incorrect packing or misplacement of items within the vehicle.

Limited Automation: While some advancements have been made in automating parts of the delivery process, such as the use of conveyor belts and basic robotic arms in warehouses, the overall system remains largely manual. Existing automation solutions are typically confined to specific tasks and are not fully integrated into a seamless, end-to-end process. This lack of comprehensive automation limits the efficiency and scalability of current delivery operations.

Environmental Control Issues: Many products, particularly perishables and temperature-sensitive goods, require specific environmental conditions during transport. However, standard delivery vehicles are often not equipped with advanced climate control systems. As a result, products may be exposed to unfavorable conditions such as temperature fluctuations, humidity, and vibrations, leading to degradation in quality or even spoilage. This issue is particularly problematic for industries like food delivery, pharmaceuticals, and electronics, where maintaining product integrity is critical.

Route Optimization Challenges: Existing route planning systems offer some degree of optimization, but they are often limited in their ability to dynamically adjust to real-time conditions, such as traffic, weather, or last-minute changes in delivery schedules. Drivers are frequently required to make on-the-spot decisions, which can lead to suboptimal routes, increased delivery times, and higher fuel consumption. Furthermore, current systems may not effectively coordinate multiple deliveries to nearby locations, missing opportunities to reduce overall travel distances and improve efficiency.

Customer Experience Limitations: The traditional delivery process provides limited transparency and real-time communication with customers. While customers may receive basic updates, such as when an order is shipped or delivered, they often lack detailed, real-time tracking information. This can lead to uncertainty about delivery times and a lack of trust in the reliability of the service. Additionally, the potential for delivery errors or product damage can result in customer dissatisfaction and increased returns, further impacting business efficiency and profitability.

### Semi-Automated and Robotic Delivery Solutions:

Emerging Technologies: In recent years, there has been a growing interest in semi-automated and robotic delivery solutions, such as drones, autonomous delivery vehicles, and warehouse robots. These technologies aim to reduce the dependency on manual labor and improve the efficiency of delivery operations. However, many of these solutions are still in the experimental or early deployment stages and face significant challenges in terms of scalability, cost, and regulatory compliance.

Integration Challenges: One of the primary challenges with existing semi-automated and robotic solutions is the lack of integration into a cohesive delivery system. For example, while autonomous vehicles and drones offer promising capabilities for last-mile delivery, they are often not fully integrated with warehouse automation, product handling, and customer communication systems. This lack of integration results in inefficiencies and potential gaps in the delivery process, where human intervention is still required to bridge the technological gaps.

Limited Environmental Adaptability: Current robotic delivery solutions may struggle to adapt to varying environmental conditions and complex delivery scenarios. For instance, drones may be limited by weather conditions, while autonomous ground vehicles may face difficulties navigating certain terrains or urban environments. These limitations restrict the applicability of such technologies to specific use cases, reducing their overall effectiveness and scalability.

### Prior Art Examples:

There is an automated warehouse system that uses robotic arms and conveyor belts to handle product picking and packing. However, the system is limited to the warehouse environment and does not address the challenges of loading, transport, and last-mile delivery. Additionally, it lacks real-time environmental monitoring and control, making it unsuitable for transporting temperature-sensitive goods.

There is a method for optimizing delivery routes using GPS and traffic data. While this method provides some degree of route optimization, it relies heavily on manual input from drivers and does not dynamically adjust to real-time conditions. Furthermore, it does not integrate with automated loading or product handling systems, limiting its overall efficiency.

There is an autonomous delivery vehicle designed for last-mile delivery in urban environments. While the vehicle offers promising capabilities, it faces significant challenges in navigating complex terrains, dealing with environmental conditions, and integrating with existing delivery infrastructure. Additionally, the system lacks comprehensive automation for loading and unloading, requiring human intervention at key stages of the delivery process.

### Problems in Prior Art Solved by the Applicant's Invention:

Comprehensive Automation: The applicant's invention addresses the limitations of prior art by providing a fully integrated, end-to-end automation solution that covers the entire delivery process, from product selection and packing to transport and last-mile delivery. The system incorporates multiple automated bots (porch bots, railed crane bots, railed fork bots, and mother bots) that work in tandem with a specialized delivery vehicle (Modern Milk Truck, MMT), creating a seamless and efficient workflow that minimizes the need for manual intervention.

Environmental Control and Monitoring: Unlike prior art systems, the applicant's invention includes advanced environmental control systems within the delivery bots and the MMT. These systems maintain optimal conditions for temperature-sensitive goods throughout the entire delivery process, ensuring product integrity from the warehouse to the customer's doorstep. Real-time monitoring and automated alerts further enhance the system's reliability, allowing for immediate corrective actions if conditions deviate from preset thresholds.

Dynamic Route Optimization: The applicant's invention leverages AI-based optimization algorithms that dynamically adjust delivery routes in real-time based on traffic conditions, weather, and other variables. This approach not only reduces delivery times and fuel consumption but also enhances the overall efficiency of the delivery process by coordinating multiple deliveries to nearby locations. The system's ability to learn from past deliveries further improves its performance over time, adapting to changing conditions and customer needs.

Enhanced Customer Experience: By providing detailed, real-time tracking and communication throughout the delivery process, the applicant's invention significantly improves the customer experience. Customers receive continuous updates on their order status, from processing to final delivery, reducing uncertainty and building trust in the service. The system's precision and reliability also minimize the risk of delivery errors and product damage, leading to higher customer satisfaction and loyalty.

The present invention overcomes the limitations and challenges of prior art by offering a comprehensive, fully automated delivery system that integrates advanced robotics, AI-based optimization, and environmental control technologies. This innovation addresses the critical inefficiencies and shortcomings of existing delivery solutions, providing a more efficient, reliable, and customer-focused approach to product transport and delivery.

### BRIEF SUMMARY OF THE INVENTION

The present invention is a comprehensive method and system for using a product transport and storage system, primarily involving the relocation of porch bots using a modern milk truck (MMT). The method includes receiving and processing electronic orders, storing products within porch bots, and relocating them to delivery addresses while integrating real-time tracking and notifications. The system leverages AI-based algorithms to optimize delivery paths and includes mechanical assistance for handling porch bots via railed crane and fork bots, as well as mother bots. Key features include advanced navigation, GPS, video analysis systems, environmental monitoring, and machine learning to optimize operations. The MMT is equipped with a hybrid power system, autonomous driving capabilities, and an advanced suspension system to ensure product safety during transit.

According to a first aspect of the invention, there is a method of using a product transport and storage system for delivering at least one container such as with a porch bot, at least one mother bot, and a modern milk truck (MMT) comprising: receiving an electronic order for a plurality of products; selecting and collecting said plurality of products; storing said plurality of products within at least one porch bot; relocating said porch bot(s) to a delivery address for a delivery of said plurality of products; including real-time order tracking and customer notifications throughout the process.

According to a second aspect of the invention, there is a method further comprising an order-to-order comparison to other pending/future orders for a user and at least one geographically proximal user for a delivery path minimized delivery, utilizing an AI-based optimization algorithm.

According to a third aspect of the invention, there is a method further comprising an ergonomically assistive object retrieval and delivery system comprising: digitally monitoring said containers, said porch bots, and said mother bots for a direction and/or a movement indicating if mechanical assistance is needed to help a delivery person move said containers, porch bots, and mother bots; when said mechanical assistance is desired, engaging at least one movement assistance motor, lever, and/or control to enable and/or assist said movement of said containers, porch bots, and mother bots; and including a user-friendly interface for manual overrides.

According to a fourth aspect of the invention, there is a method wherein relocating said porch bot to said delivery address for said products further comprises: moving said porch bot(s) into an MMT; lifting and positioning said porch bot(s) for stowage within said MMT by using a railed crane bot; transporting said porch bot(s) to said delivery address; unloading said porch bot(s) using said railed crane bot; transporting said porch bot(s) to a delivery position; and including an automated alignment system for precise loading and unloading.

According to a fifth aspect of the invention, there is a method wherein relocating said porch bot(s) to said delivery address for said products further comprises: moving said porch bot(s) into said MMT; lifting and positioning said porch bot(s) for stowage within said MMT using a railed fork bot comprising a base end distal from a distal end having tines of a fork to lift said porch bot(s), wherein said fork extends from a carriage which slides along a rail arm from said base end to said distal end, and said base end is configured to support said railed fork bot vertically from a floor of a truck trailer, and said distal end comprises a rail car interface to connect to a rail car on a roof of said truck trailer to stabilize said rail car as a column; transporting said porch bot(s) to said delivery address; unloading said porch bot(s) using said railed fork bot; transporting said porch bot(s) to a delivery position; and featuring a safety mechanism to secure the porch bots during transit.

According to a sixth aspect of the invention, there is a method wherein relocating said porch bot(s) to said delivery address for said products further comprises: moving said porch bot(s) into said MMT with a method comprising lifting and positioning said porch bot(s) for stowage within said MMT using said mother bot; transporting said porch bot(s) to said delivery address; unloading said porch bot(s) using said mother bot(s); transporting said porch bot(s) to a delivery position; and integrating a real-time monitoring system for environmental conditions within the porch bots.

According to a seventh aspect of the invention, there is a method wherein transporting said porch bot(s) to a delivery position for a plurality of porch bots to be delivered to said delivery position is a method of transporting said plurality of porch bots together upon at least one mother bot prior to unloading said plurality of porch bots for transport to said delivery position, including a coordinated unloading mechanism for efficient delivery.

According to an eighth aspect of the invention, there is a method further comprising a navigation and GPS system and a position streaming system enhanced in over/under layers with at least one of: a location tracking label (planet codes, cubic codes, etc), an optical/video systems integration (ultraviolet, infrared, satellite imagery), a geolocation data integration, and incorporating predictive analytics for route optimization.

According to a ninth aspect of the invention, there is a method further comprising any combination of: a visual video analysis system integration for bot way-finding, an infrared video analysis system integration for enhancing said bot way-finding, an ultraviolet video analysis system integration for enhancing said bot way-finding, a weather data analysis system integration for enhancing said bot way-finding, a satellite data analysis system integration for enhancing said bot way-finding, and integrating machine learning algorithms for continuous improvement of navigation accuracy.

According to a tenth aspect of the invention, there is a method of using a product transport and storage system comprising: a plurality of porch bots, one of said plurality of porch bots being a first porch bot, a railed crane bot comprising a roof rail to be connected to a roof of a truck trailer longitudinally intermediate a front wall and an opposite rear door of said truck trailer, a rail car which runs longitudinally along said roof rail, wherein suspended from said rail car is a winch having a cord with a free end with a hook to lift and position said porch bot, at least one mother bot comprising a bed having a side to support said porch bots, and an adjustable height lift connected to an opposite side of said bed from said side to support said porch bots, wherein said adjustable height lift is configured to raise, lower, and translate said bed from a surface, wherein at least one porch bot is placeable in said truck trailer to store and transport cases of groceries, said railed crane bot is connected to said roof of said truck trailer to lift and place said porch bot(s) at least within said truck trailer, and said bed of said mother bot is moveable vertically and horizontally to transport said porch bot(s) to and from said truck trailer to a surface on a porch, patio, or landing, the steps of the method comprising: receiving an electronic order for a plurality of products, selecting and collecting said plurality of products then storing said products within said plurality of porch bots, relocating said plurality of porch bots to a delivery address for said products, and integrating a quality assurance system to verify product integrity during transport.

According to an eleventh aspect of the invention, there is a method of using a product transport and storage system wherein relocating said porch bot to a delivery address for said products further comprises: moving said porch bot into a modern milk truck (MMT), lifting and positioning said porch bot for stowage within said MMT using said railed crane bot, transporting said porch bot to said delivery address, unloading said porch bot using said railed crane bot, transporting said porch bot to a delivery position, and featuring an automated temperature control system within the porch bots.

According to a twelfth aspect of the invention, there is a method of using a product transport and storage system wherein relocating said porch bot to a delivery address for said products further comprises: moving said porch bot into a modern milk truck (MMT), lifting and positioning said porch bot for stowage within said MMT using a railed fork bot comprising a base end distal from a distal end, tines of a fork to lift said porch bot wherein said fork extends from a carriage which slides along a rail arm from said base end to a distal end, and said base end is configured to support said railed fork bot vertically from a floor of said truck trailer, and said distal end comprises a rail car interface to connect to a rail car on a roof of said truck trailer to stabilize said rail car as a column, transporting said porch bot to said delivery address, unloading said porch bot using said railed fork bot, transporting said porch bot to a delivery position, and including a security system to protect the products during transport.

According to a thirteenth aspect of the invention, there is a method of using a product transport and storage system wherein relocating said porch bot to a delivery address for said products further comprises: moving said porch bot into a modern milk truck (MMT) with a method comprising: lifting and positioning said porch bot for stowage within said MMT using said mother bot, transporting said porch bot to said delivery address, unloading said porch bot using said mother bot, transporting said porch bot to a delivery position, and integrating an automated handling system for seamless transition between bots.

According to a fourteenth aspect of the invention, there is a method of using a product transport and storage system wherein transporting said porch bot to a delivery position for a plurality of porch bots to be delivered to said delivery position is a method of transporting said plurality of porch bots together upon said mother bot prior to unloading said plurality of porch bots for transport to said delivery position, featuring an optimized loading and unloading sequence to minimize delivery time.

According to a fifteenth aspect of the invention, there is a modern milk truck (MMT) configured for moving a porch bot comprising: a delivery vehicle, any combination of: a porch elevator bot, a railed crane bot, a railed fork bot integrated therein, featuring an integrated control system to manage the operations of the porch elevator bot, railed crane bot, and railed fork bot, a monitoring system to track the condition and status of the porch bots during transit, and a communication system to relay real-time information to a central control center for coordinated operations.

According to a sixteenth aspect of the invention, there is a modern milk truck (MMT) further comprising a hybrid power system integrating both electric and diesel power sources, wherein the MMT automatically switches between power sources based on route conditions and load requirements to optimize fuel efficiency.

According to a seventeenth aspect of the invention, there is a modern milk truck (MMT) wherein said monitoring system further comprises an environmental control system that adjusts the internal climate of the MMT's cargo area to maintain the temperature and humidity levels required for the specific products being transported, including automated alerts if conditions fall outside pre-set thresholds.

According to an eighteenth aspect of the invention, there is a modern milk truck (MMT) further comprising an advanced suspension system specifically designed to minimize vibrations and shocks during transport, thereby protecting delicate products and ensuring the integrity of the porch bots and their contents.

According to a nineteenth aspect of the invention, there is a modern milk truck (MMT) wherein said integrated control system includes a machine learning module that analyzes historical delivery data to optimize route planning, loading, and unloading processes, continuously improving efficiency and reducing delivery times over repeated use.

According to a twentieth aspect of the invention, there is a modern milk truck (MMT) further comprising an autonomous driving capability, wherein the MMT can be operated in a semi-autonomous mode for highway driving, with safety and navigation systems designed to maintain lane position, avoid collisions, and automatically adjust speed based on traffic conditions.

The invention offers several key advantages:

Increased Efficiency: The integration of automated bots (porch bots, railed crane bots, railed fork bots, and mother bots) with a specialized delivery vehicle (the Modern Milk Truck, or MMT) streamlines the product delivery process, reducing time and labor requirements.

Enhanced Accuracy: Real-time order tracking, AI-based optimization, and automated alignment systems ensure precise loading, unloading, and delivery, minimizing errors and improving customer satisfaction.

Improved Safety: The system includes mechanical assistance for handling heavy or bulky items, reducing the risk of injury to delivery personnel. Additionally, advanced suspension and environmental control systems protect delicate products during transit.

Optimized Delivery Routes: AI and machine learning algorithms continuously improve route planning, loading, and unloading processes, resulting in reduced delivery times and increased operational efficiency.

Flexibility and Scalability: The system is adaptable to various delivery environments and product types, making it suitable for a wide range of applications, from groceries to specialized goods requiring specific handling conditions.

Environmental Sustainability: The MMT's hybrid power system optimizes fuel efficiency by automatically switching between electric and diesel power sources based on route conditions, contributing to lower emissions and reduced environmental impact.

Autonomous and Semi-Autonomous Capabilities: The MMT's autonomous driving and advanced navigation systems enhance safety and reduce the need for manual intervention during highway driving and other routine delivery operations.

Overall, the invention provides a comprehensive solution for modernizing and optimizing product delivery, combining advanced robotics, automation, and intelligent systems to meet the demands of contemporary logistics and consumer expectations.

The invention will now be described, by way of example only, with reference to the accompanying figures in which:

### BRIEF DESCRIPTION OF THE FIGURES

FIG. 1 is a flowchart illustrating the process of the MMT and a method of using a product transport and storage system for delivering containers and packages according to the invention; and

FIG. 2 is a side view of the MMT with bots inside according to the invention.

### DETAILED DESCRIPTION OF THE INVENTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Index of Labelled Features in Figures. Features are listed in numeric order by Figure in numeric order.

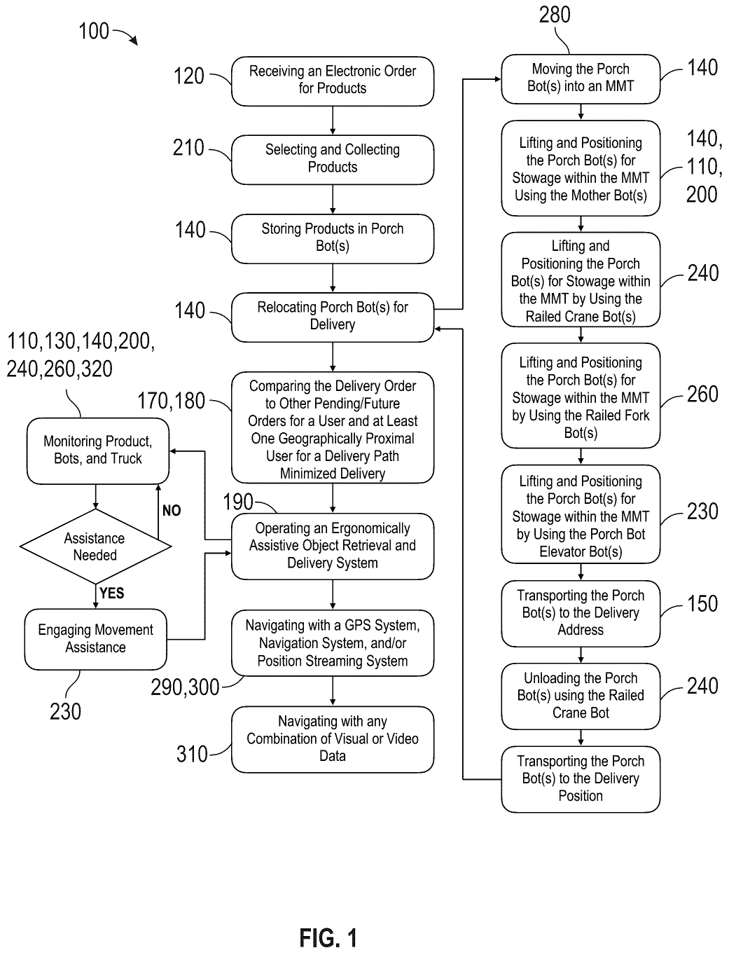

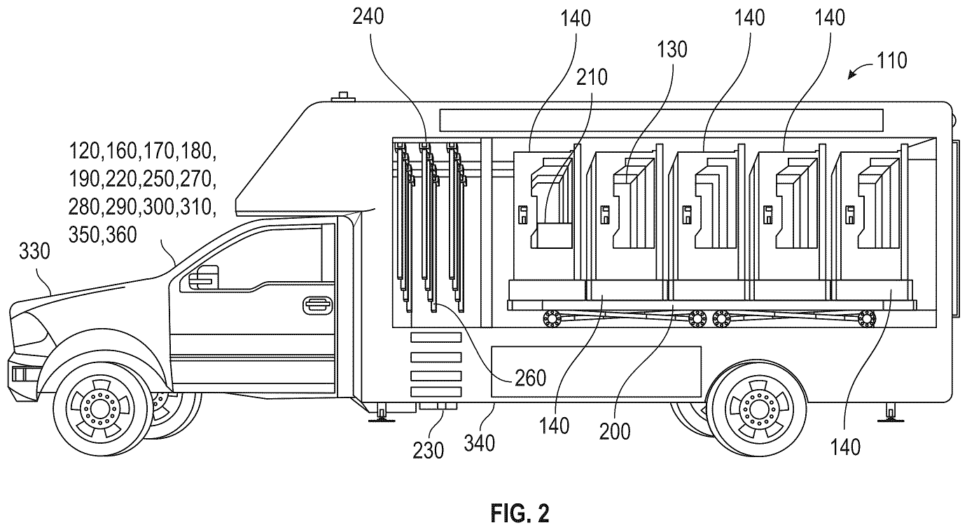

Referring to the Figures, there is shown in FIGS. 1, 2, 3, and 4 the following features:

Element 100 which is a method of using a product transport and storage system for delivering at least one container with a modern milk truck (MMT).

Element 110 which is a modern milk truck (MMT)/truck.

Element 120 which is an electronic order.

Element 130 which is a plurality of products.

Element 140 which is a porch bot.

Element 150 which is a delivery address.

Element 160 which is real-time order tracking and customer notifications.

Element 170 which is an order-to-order comparison to other pending/future orders.

Element 180 which is a delivery path minimized delivery.

Element 190 which is an ergonomically assistive object retrieval and delivery system.

Element 200 which is a mother bot.

Element 210 which is a container.

Element 220 which is a delivery person.

Element 230 which is a mechanical assistance.

Element 240 which is a railed crane bot.

Element 250 which is an automated alignment system.

Element 260 which is a railed fork bot.

Element 270 which is a real-time monitoring system for environmental conditions.

Element 280 which is a coordinated unloading mechanism for efficient delivery.

Element 290 which is a navigation and GPS system.

Element 300 which is a position streaming system.

Element 310 which is any combination of: a visual video analysis system integration for bot way-finding, an infrared video analysis system integration for enhancing said bot way-finding, an ultraviolet video analysis system integration for enhancing said bot way-finding, a weather data analysis system integration for enhancing said bot way-finding, a satellite data analysis system integration for enhancing said bot way-finding, and integrating machine learning algorithms for continuous improvement of navigation accuracy Element 320 which is a porch elevator bot.

Element 330 which is a hybrid power system.

Element 340 which is an advanced suspension system.

Element 350 which is an integrated control system.

Element 360 which is an autonomous driving capability.

### How to Make the Invention:

### Manufacturing the Porch Bots:

Design and Structural Framework: Begin by designing a modular frame for the porch bots, made from lightweight, high-strength materials such as aluminum alloy or carbon fiber composites. The frame should be able to support the weight of various products and withstand environmental conditions, such as rain, snow, and temperature fluctuations. The bot's design should include a base platform with multiple compartments or adjustable shelving to accommodate different types of products, from small packages to larger items like grocery crates. These compartments can be designed with adjustable dividers to secure products of varying sizes and shapes. The bot's outer casing should be weatherproof, with seals and gaskets at all access points to protect against moisture, dust, and other environmental factors. The casing could also include insulation to help maintain internal temperature stability.

Mobility System: Equip the porch bots with a mobility system that includes all-terrain wheels or tracks, allowing them to navigate various surfaces such as sidewalks, driveways, and porches. Consider integrating suspension systems to help the bots traverse uneven terrain without damaging the cargo. Install electric motors in the wheels or tracks to provide propulsion, with each motor connected to a central control unit for coordinated movement. This setup allows for precision control, including forward/reverse movement, turning, and speed adjustment. Include sensors such as LIDAR, ultrasonic sensors, and cameras for obstacle detection and navigation, ensuring the porch bots can autonomously navigate to their designated delivery positions.

Power Supply and Charging System: Integrate a rechargeable lithium-ion battery pack into each porch bot. The battery should be capable of providing enough power for multiple deliveries on a single charge, with considerations for power-hungry features like climate control or heavy loads. Design the porch bots with an easy-access charging port, and consider incorporating wireless charging capabilities for convenience. The bots could automatically dock with a charging station when not in use or during loading/unloading operations. Implement power management software to optimize battery usage, including features like energy-efficient modes, power-saving algorithms, and alerts for low battery levels.

Sensors, Electronics, and Control Systems: Equip each porch bot with a suite of sensors, including GPS for location tracking, temperature and humidity sensors for environmental monitoring, and load sensors to detect the weight and distribution of the cargo. Install a microcontroller unit (MCU) to serve as the central brain of the porch bot, coordinating all sensor inputs, motor controls, and communication with the MMT and central command center. The MCU should support wireless communication protocols such as Wi-Fi, Bluetooth, or cellular data. Implement an embedded operating system and software that allows the porch bot to autonomously navigate, monitor environmental conditions, and respond to real-time commands from the central control system.

Communication and User Interface: Integrate a communication module that enables real-time data exchange between the porch bots, MMT, and central command center. This could include cellular connectivity for remote operation and updates, and short-range communication (e.g., Bluetooth) for interactions with delivery personnel or customers. Develop a user interface (UI) accessible via a touchscreen on the porch bot or a mobile app, allowing delivery personnel to input manual commands, override automated functions, and monitor the bot's status. The UI should be intuitive and user-friendly, with clear indicators for battery level, route status, and environmental conditions.

### Developing the Railed Crane Bot and Railed Fork Bot:

Rail System Design and Installation: Design the rail system to be installed within the cargo area of the Modern Milk Truck (MMT). The rail system should include a roof rail running the length of the truck, secured to the roof with reinforced brackets. Consider using a durable, low-friction material for the rail, such as stainless steel or anodized aluminum, to ensure smooth operation. Install floor rails or support structures on the truck's cargo floor to provide additional stability and alignment for the railed crane and fork bots. These rails should be aligned with the roof rail to ensure synchronized movement of the bots.

Railed Crane Bot Construction: Construct the railed crane bot with a rail car that moves along the roof rail. The rail car should be powered by an electric motor with gear-driven wheels to ensure smooth and precise movement along the rail. Attach a winch system to the rail car, with a high-tensile strength cord that can handle the weight of a fully loaded porch bot. The winch should include an automated spooling mechanism to control the cord's length during lifting and lowering operations. Equip the winch's free end with a hook or grappling mechanism designed to securely attach to the porch bots. The hook should have an automatic locking feature to ensure a secure grip during movement and release.

Railed Fork Bot Construction: Design the railed fork bot with a base that slides along the floor rails or a designated support structure within the truck. The base should include a motorized carriage that allows the bot to extend and retract along the rail arm. Construct the fork mechanism with adjustable tines that can lift and support porch bots of various sizes. The tines should be powered by hydraulic or electric actuators to handle heavy loads with precision and control. Integrate a stabilization mechanism into the fork bot's base, connecting it to a rail car on the truck's roof. This stabilization system ensures that the fork bot remains balanced and aligned during loading/unloading operations.

Motorization, Sensors, and Control Systems: Both the railed crane and fork bots should be equipped with sensors for position tracking, load detection, and obstacle avoidance. These sensors should be integrated into the bots' control systems to enable autonomous operation and precise coordination with the MMT's central system. Develop control software that allows the bots to execute complex loading/unloading sequences automatically or in response to manual commands. The software should include safety features, such as collision detection and emergency stop functions.

### Building the Mother Bot:

Chassis and Lift Mechanism Design: Design the mother bot with a flatbed chassis that can accommodate multiple porch bots. The flatbed should be made from a durable, lightweight material, such as reinforced aluminum, and equipped with adjustable clamps or brackets to secure the porch bots during transport. Install an adjustable height lift mechanism on the opposite side of the flatbed, allowing the mother bot to raise and lower the porch bots for loading/unloading. This lift mechanism could be powered by hydraulics, electric actuators, or a combination of both, depending on the weight capacity required. Ensure the lift mechanism includes precise control systems, allowing for smooth and gradual lifting/lowering operations to prevent jostling or tipping of the porch bots.

Mobility and Steering Systems: Equip the mother bot with a robust mobility system, including all-terrain wheels or tracks for navigating various surfaces. The bot should have independent wheel control or articulated steering to maneuver in tight spaces, such as narrow driveways or crowded porches. Integrate an advanced navigation system that includes GPS, LIDAR, and cameras for autonomous movement. The mother bot should be able to detect and avoid obstacles, follow pre-programmed routes, and adjust its path in real time based on environmental conditions.

Automation and Control Integration: Install a centralized control unit on the mother bot that coordinates its movements and operations with the other bots and the MMT's central system. The control unit should be capable of receiving and executing complex commands, such as simultaneous movement of multiple porch bots. Develop software that allows the mother bot to operate autonomously or in tandem with human operators. The software should include features for route planning, load management, and safety overrides.

### Modern Milk Truck (MMT) Construction:

Vehicle Base and Chassis Design: Start with a delivery vehicle chassis capable of supporting the combined weight of the bots and their cargo. The chassis should be reinforced with high-strength materials to handle heavy loads and equipped with a hybrid powertrain for efficient operation. Design the cargo area to accommodate the rail systems for the railed crane and fork bots, with sufficient clearance for the bots to operate without obstruction. Consider including modular sections or adjustable panels in the cargo area to adapt to different load sizes and configurations.

Integration of Bots and Control Systems: Install the rail systems within the MMT's cargo area, ensuring they are securely mounted and aligned for smooth operation of the railed crane and fork bots. The rail systems should be designed for easy maintenance and replacement of components if needed. Secure mounting points within the cargo area for the mother bot, ensuring it can be easily loaded and unloaded. The mounting points should include locking mechanisms to prevent movement during transit. Equip the MMT with a central control system that manages the operations of all bots, environmental controls, and real-time monitoring. This control system should be connected to the vehicle's onboard computer, allowing for coordinated operation with the vehicle's driving systems.

Advanced Suspension and Environmental Control Systems: Install an advanced suspension system designed to minimize vibrations and shocks during transport. This system should be adjustable based on load weight and road conditions, ensuring a smooth ride for delicate products. Implement environmental control systems within the cargo area, including climate control units for temperature and humidity regulation. These systems should be connected to sensors within the porch bots to maintain optimal conditions for the specific products being transported. Integrate automated alerts and response mechanisms within the environmental control system, allowing for immediate corrective actions if conditions deviate from preset thresholds.

Autonomous Driving and Navigation Systems: Equip the MMT with autonomous driving capabilities, including sensors for lane-keeping, collision avoidance, and adaptive cruise control. The vehicle should be capable of operating in semi-autonomous mode during highway driving and other routine operations. Develop navigation software that integrates with the MMT's central control system, allowing the vehicle to follow optimized routes based on real-time data from the bots and external traffic/weather conditions.

### Software and AI Integration:

AI-Based Optimization and Learning Algorithms: Develop AI algorithms that optimize route planning, loading/unloading sequences, and overall delivery efficiency. These algorithms should be capable of analyzing historical delivery data, traffic patterns, customer preferences, and real-time conditions to continuously improve operations. Implement machine learning modules that allow the system to learn from past deliveries, refining its predictions and decision-making processes over time. This could include adapting to customer behaviors, optimizing delivery schedules, and improving fuel efficiency.

Real-Time Monitoring and Communication Systems: Implement real-time monitoring software that tracks the status of each porch bot, the MMT, and the delivery process as a whole. This software should be capable of monitoring environmental conditions, bot locations, battery levels, and other critical parameters. Integrate a communication system that allows for constant data exchange between the bots, MMT, and central command center. This could include cellular connectivity for remote operations and updates, as well as short-range communication for interactions with delivery personnel or customers.

User Interface and Control Systems: Develop a comprehensive user interface (UI) that allows operators to interact with the system, monitor its status, and input manual commands as needed. The UI should be accessible via touchscreen displays on the bots and MMT, as well as through a mobile app for remote access. The UI should include features like real-time tracking, environmental monitoring, route adjustments, and emergency overrides. It should also provide clear indicators for system health, battery levels, and other critical information. How to Use the Invention:

### Receiving and Processing Orders:

Order Management: The process begins when an electronic order is placed through a customer-facing platform, such as an e-commerce website or mobile app. The order details, including the specific products, delivery address, and any special handling requirements, are transmitted to the central control system. The AI algorithms analyze the order, assessing factors like product size, weight, delivery location, and any specific customer preferences. The system also compares the new order with other pending orders to optimize delivery routes and loading sequences.

Product Selection and Collection: Once the order is processed, the system directs warehouse personnel or automated systems to select and collect the specified products. These products are then organized and packed within the designated compartments of the porch bots. If the order includes products requiring special handling, such as temperature-sensitive items, the porch bots' environmental control systems are adjusted accordingly to maintain the required conditions during transport.

Loading the Porch Bots into the MMT:

Automated Loading Process: The porch bots, now loaded with the customer's order, are moved to the loading area where the MMT is parked. The railed crane bot and railed fork bot, installed within the MMT's cargo area, are activated to begin the loading process. The railed crane bot moves along the roof rail, lowering its winch to lift the porch bots from the loading platform and position them within the truck's cargo area. The railed fork bot can assist by lifting and stabilizing the porch bots from below, ensuring they are securely stowed. The loading process is carefully managed by the central control system, which coordinates the movements of the bots to prevent collisions and ensure that each porch bot is placed in its designated location within the MMT.

Safety and Stability Checks: Once the porch bots are loaded into the MMT, the system performs a series of safety checks to ensure that they are securely fastened and stable. The bots are locked into place using automated clamps or brackets, and the MMT's suspension system is adjusted to accommodate the load. The system also verifies that the environmental controls within the porch bots and the MMT's cargo area are functioning correctly, maintaining the optimal conditions for the products during transport.

### Transporting the Porch Bots to the Delivery Address:

Optimized Delivery Route: With the porch bots securely loaded, the MMT is ready to begin its journey to the delivery address. The AI-based optimization algorithms calculate the most efficient route, taking into account real-time traffic data, weather conditions, and delivery priorities. The MMT's autonomous driving systems can be engaged, allowing the vehicle to operate in semi-autonomous mode during highway driving or in traffic. The system continuously monitors the route, making adjustments as needed to ensure timely and efficient delivery.

Real-Time Monitoring and Communication: Throughout the journey, the central control system monitors the status of the porch bots, the MMT, and the delivery process. Environmental conditions within the cargo area are tracked in real-time, with automated alerts if any deviations occur. The system also provides real-time updates to customers, allowing them to track their delivery progress through a mobile app or website. Notifications are sent at key stages, such as when the MMT departs the warehouse, arrives at the delivery area, and completes the delivery.

### Unloading and Delivering the Porch Bots:

Automated Unloading Process: Upon arrival at the delivery address, the MMT's autonomous systems identify the precise delivery location, such as the customer's porch, driveway, or a designated drop-off point. The railed crane bot and railed fork bot are then activated to begin the unloading process. The railed crane bot lifts the porch bots from their secured positions within the MMT and lowers them to the ground or onto the mother bot for final delivery. The railed fork bot can assist by guiding the porch bots to ensure smooth and accurate placement. If multiple porch bots are being delivered to the same location, the mother bot can transport them together from the MMT to the final delivery position, minimizing the need for multiple trips and reducing delivery time.

Final Delivery and Confirmation: The porch bots autonomously navigate to the designated delivery position, using their onboard sensors and navigation systems to avoid obstacles and ensure precise placement. The customer can receive a notification when the porch bot arrives at their location. Once the delivery is complete, the system confirms the successful handoff of the products, updating the central control system and notifying the customer. The porch bots then return to the MMT or prepare for the next delivery.

### Completing the Delivery Cycle:

Returning to Base or Next Delivery: After completing the deliveries, the MMT can either return to the distribution center for reloading or proceed to the next delivery location based on the optimized route plan. The system continuously adjusts the route in real-time to accommodate new orders or changes in delivery priorities. During transit, the MMT's environmental control systems maintain the required conditions for any remaining products, ensuring they arrive in optimal condition at their next destination.

Maintenance, Recharging, and System Updates: At the end of the delivery cycle, the porch bots and MMT undergo maintenance checks to ensure they are in good working order. The bots' batteries are recharged or replaced as needed, and any wear-and-tear on components is addressed. The system's AI algorithms are updated based on the day's data, refining their predictions and improving efficiency for future deliveries. This continuous learning process helps the system adapt to changing conditions and customer needs over time.

System Integration and Feedback: The system integrates feedback from delivery personnel, customers, and operational data to continuously improve its performance. This includes adjusting AI algorithms, updating software, and making hardware modifications as necessary to enhance efficiency, safety, and customer satisfaction.

This detailed description outlines the step-by-step process for making and using the invention, ensuring that it operates effectively and efficiently in delivering products while leveraging advanced automation, AI, and environmental control technologies.

According to a preferred embodiment of the invention, there is a method of using a product transport and storage system for delivering at least one container such as with a porch bot, at least one mother bot, and a modern milk truck (MMT) comprising: receiving an electronic order for a plurality of products; selecting and collecting said plurality of products; storing said plurality of products within at least one porch bot; relocating said porch bot(s) to a delivery address for a delivery of said plurality of products; including real-time order tracking and customer notifications throughout the process.

According to an alternate embodiment of the invention, there is a method further comprising an order-to-order comparison to other pending/future orders for a user and at least one geographically proximal user for a delivery path minimized delivery, utilizing an AI-based optimization algorithm.

According to an alternate embodiment of the invention, there is a method further comprising an ergonomically assistive object retrieval and delivery system comprising: digitally monitoring said containers, said porch bots, and said mother bots for a direction and/or a movement indicating if mechanical assistance is needed to help a delivery person move said containers, porch bots, and mother bots; when said mechanical assistance is desired, engaging at least one movement assistance motor, lever, and/or control to enable and/or assist said movement of said containers, porch bots, and mother bots; and including a user-friendly interface for manual overrides.

According to an alternate embodiment of the invention, there is a method wherein relocating said porch bot to said delivery address for said products further comprises: moving said porch bot(s) into an MMT; lifting and positioning said porch bot(s) for stowage within said MMT by using a railed crane bot; transporting said porch bot(s) to said delivery address; unloading said porch bot(s) using said railed crane bot; transporting said porch bot(s) to a delivery position; and including an automated alignment system for precise loading and unloading.

According to an alternate embodiment of the invention, there is a method wherein relocating said porch bot(s) to said delivery address for said products further comprises: moving said porch bot(s) into said MMT; lifting and positioning said porch bot(s) for stowage within said MMT using a railed fork bot comprising a base end distal from a distal end having tines of a fork to lift said porch bot(s), wherein said fork extends from a carriage which slides along a rail arm from said base end to said distal end, and said base end is configured to support said railed fork bot vertically from a floor of a truck trailer, and said distal end comprises a rail car interface to connect to a rail car on a roof of said truck trailer to stabilize said rail car as a column; transporting said porch bot(s) to said delivery address; unloading said porch bot(s) using said railed fork bot; transporting said porch bot(s) to a delivery position; and featuring a safety mechanism to secure the porch bots during transit.

According to an alternate embodiment of the invention, there is a method wherein relocating said porch bot(s) to said delivery address for said products further comprises: moving said porch bot(s) into said MMT with a method comprising lifting and positioning said porch bot(s) for stowage within said MMT using said mother bot; transporting said porch bot(s) to said delivery address; unloading said porch bot(s) using said mother bot(s); transporting said porch bot(s) to a delivery position; and integrating a real-time monitoring system for environmental conditions within the porch bots.

According to an alternate embodiment of the invention, there is a method wherein transporting said porch bot(s) to a delivery position for a plurality of porch bots to be delivered to said delivery position is a method of transporting said plurality of porch bots together upon at least one mother bot prior to unloading said plurality of porch bots for transport to said delivery position, including a coordinated unloading mechanism for efficient delivery.

According to an alternate embodiment of the invention, there is a method further comprising a navigation and GPS system and a position streaming system enhanced in over/under layers with at least one of: a location tracking label (planet codes, cubic codes, etc), an optical/video systems integration (ultraviolet, infrared, satellite imagery), a geolocation data integration, and incorporating predictive analytics for route optimization.

According to an alternate embodiment of the invention, there is a method further comprising any combination of: a visual video analysis system integration for bot way-finding, an infrared video analysis system integration for enhancing said bot way-finding, an ultraviolet video analysis system integration for enhancing said bot way-finding, a weather data analysis system integration for enhancing said bot way-finding, a satellite data analysis system integration for enhancing said bot way-finding, and integrating machine learning algorithms for continuous improvement of navigation accuracy.

According to a preferred embodiment of the invention, there is a method of using a product transport and storage system comprising: a plurality of porch bots, one of said plurality of porch bots being a first porch bot, a railed crane bot comprising a roof rail to be connected to a roof of a truck trailer longitudinally intermediate a front wall and an opposite rear door of said truck trailer, a rail car which runs longitudinally along said roof rail, wherein suspended from said rail car is a winch having a cord with a free end with a hook to lift and position said porch bot, at least one mother bot comprising a bed having a side to support said porch bots, and an adjustable height lift connected to an opposite side of said bed from said side to support said porch bots, wherein said adjustable height lift is configured to raise, lower, and translate said bed from a surface, wherein at least one porch bot is placeable in said truck trailer to store and transport cases of groceries, said railed crane bot is connected to said roof of said truck trailer to lift and place said porch bot(s) at least within said truck trailer, and said bed of said mother bot is moveable vertically and horizontally to transport said porch bot(s) to and from said truck trailer to a surface on a porch, patio, or landing, the steps of the method comprising: receiving an electronic order for a plurality of products, selecting and collecting said plurality of products then storing said products within said plurality of porch bots, relocating said plurality of porch bots to a delivery address for said products, and integrating a quality assurance system to verify product integrity during transport.

According to an alternate embodiment of the invention, there is a method of using a product transport and storage system wherein relocating said porch bot to a delivery address for said products further comprises: moving said porch bot into a modern milk truck (MMT), lifting and positioning said porch bot for stowage within said MMT using said railed crane bot, transporting said porch bot to said delivery address, unloading said porch bot using said railed crane bot, transporting said porch bot to a delivery position, and featuring an automated temperature control system within the porch bots.

According to an alternate embodiment of the invention, there is a method of using a product transport and storage system wherein relocating said porch bot to a delivery address for said products further comprises: moving said porch bot into a modern milk truck (MMT), lifting and positioning said porch bot for stowage within said MMT using a railed fork bot comprising a base end distal from a distal end, tines of a fork to lift said porch bot wherein said fork extends from a carriage which slides along a rail arm from said base end to a distal end, and said base end is configured to support said railed fork bot vertically from a floor of said truck trailer, and said distal end comprises a rail car interface to connect to a rail car on a roof of said truck trailer to stabilize said rail car as a column, transporting said porch bot to said delivery address, unloading said porch bot using said railed fork bot, transporting said porch bot to a delivery position, and including a security system to protect the products during transport.

According to an alternate embodiment of the invention, there is a method of using a product transport and storage system wherein relocating said porch bot to a delivery address for said products further comprises: moving said porch bot into a modern milk truck (MMT) with a method comprising: lifting and positioning said porch bot for stowage within said MMT using said mother bot, transporting said porch bot to said delivery address, unloading said porch bot using said mother bot, transporting said porch bot to a delivery position, and integrating an automated handling system for seamless transition between bots.

According to an alternate embodiment of the invention, there is a method of using a product transport and storage system wherein transporting said porch bot to a delivery position for a plurality of porch bots to be delivered to said delivery position is a method of transporting said plurality of porch bots together upon said mother bot prior to unloading said plurality of porch bots for transport to said delivery position, featuring an optimized loading and unloading sequence to minimize delivery time.

According to a preferred embodiment of the invention, there is a modern milk truck (MMT) configured for moving a porch bot comprising: a delivery vehicle, any combination of: a porch elevator bot, a railed crane bot, a railed fork bot integrated therein, featuring an integrated control system to manage the operations of the porch elevator bot, railed crane bot, and railed fork bot, a monitoring system to track the condition and status of the porch bots during transit, and a communication system to relay real-time information to a central control center for coordinated operations.

According to an alternate embodiment of the invention, there is a modern milk truck (MMT) further comprising a hybrid power system integrating both electric and diesel power sources, wherein the MMT automatically switches between power sources based on route conditions and load requirements to optimize fuel efficiency.

According to an alternate embodiment of the invention, there is a modern milk truck (MMT) wherein said monitoring system further comprises an environmental control system that adjusts the internal climate of the MMT's cargo area to maintain the temperature and humidity levels required for the specific products being transported, including automated alerts if conditions fall outside pre-set thresholds.

According to an alternate embodiment of the invention, there is a modern milk truck (MMT) further comprising an advanced suspension system specifically designed to minimize vibrations and shocks during transport, thereby protecting delicate products and ensuring the integrity of the porch bots and their contents.

According to an alternate embodiment of the invention, there is a modern milk truck (MMT) wherein said integrated control system includes a machine learning module that analyzes historical delivery data to optimize route planning, loading, and unloading processes, continuously improving efficiency and reducing delivery times over repeated use.

According to an alternate embodiment of the invention, there is a modern milk truck (MMT) further comprising an autonomous driving capability, wherein the MMT can be operated in a semi-autonomous mode for highway driving, with safety and navigation systems designed to maintain lane position, avoid collisions, and automatically adjust speed based on traffic conditions.

The advantages of the present invention include:

Increased Operational Efficiency: The invention significantly streamlines the product delivery process by integrating multiple automated bots—such as porch bots, railed crane bots, railed fork bots, and mother bots—with the Modern Milk Truck (MMT). This combination allows for seamless coordination between the different stages of product handling, from loading and transport to delivery. By automating tasks like loading and unloading, the system reduces the time and labor traditionally required for these activities. This leads to faster turnaround times and higher throughput, allowing delivery operations to handle more orders in less time.

Enhanced Accuracy and Precision: The use of real-time order tracking and AI-based optimization ensures that every aspect of the delivery process is meticulously managed. The system can dynamically adjust delivery routes, loading sequences, and product placement within the vehicle to minimize errors. Automated alignment systems, both for loading and unloading, ensure that porch bots and other delivery units are precisely positioned, reducing the likelihood of product damage or misplacement. This precision is particularly beneficial when handling fragile or perishable goods.

Improved Safety for Personnel and Products: The invention includes mechanical assistance features that support the safe handling of heavy or awkwardly shaped items, reducing the physical strain on delivery personnel and lowering the risk of work-related injuries. The MMT's advanced suspension system is specifically designed to minimize vibrations and shocks during transport, which is crucial for protecting delicate products. This, combined with the environmental control systems, ensures that items like groceries, pharmaceuticals, and electronics arrive in optimal condition.

Optimized Delivery Routes and Load Management: The system employs AI and machine learning algorithms to continuously analyze historical delivery data, customer preferences, traffic patterns, and other variables. This allows it to optimize delivery routes, minimize travel time, and reduce fuel consumption. Load management is also optimized, with the system capable of determining the most efficient loading and unloading sequences. This not only speeds up the process but also ensures that the most urgent deliveries are prioritized without compromising overall efficiency.

Flexibility and Scalability Across Various Applications: The invention is designed to be highly adaptable, capable of handling a wide range of products, from everyday groceries to specialized items requiring specific handling conditions, such as medical supplies or temperature-sensitive goods. The modular nature of the system allows it to scale easily. Whether serving a small local area or a large metropolitan region, the system can be expanded or adjusted to meet varying demand levels, making it suitable for different business sizes and types.

Environmental Sustainability and Reduced Operational Costs: The MMT's hybrid power system intelligently switches between electric and diesel power based on route conditions, load requirements, and energy availability. This optimizes fuel efficiency, reducing overall energy consumption and lowering greenhouse gas emissions. This sustainable approach not only benefits the environment but also reduces operational costs over time, as the system minimizes fuel usage and maximizes the lifespan of vehicle components through smart energy management.

Autonomous and Semi-Autonomous Driving Capabilities: The MMT is equipped with autonomous driving features that allow it to operate in a semi-autonomous mode, particularly during highway driving. This capability enhances safety by maintaining lane position, avoiding collisions, and adjusting speed according to traffic conditions. These autonomous features reduce the need for constant human intervention, allowing drivers to focus on more complex tasks or rest during long hauls, ultimately improving overall efficiency and safety in the delivery process.

Advanced Monitoring and Control Systems: The system's comprehensive monitoring and control mechanisms ensure that every aspect of the delivery process is under constant supervision. Environmental control systems within the MMT and porch bots maintain the required temperature and humidity levels, with automated alerts if conditions deviate from preset thresholds. The integration of real-time communication systems allows for continuous updates to a central control center, enabling coordinated operations and immediate responses to any issues that arise during transit.

Enhanced Customer Experience: Real-time tracking and customer notifications keep recipients informed throughout the delivery process, providing transparency and reducing anxiety about delivery times and product condition. The precision and reliability of the system translate to higher customer satisfaction, as deliveries are more likely to arrive on time and in perfect condition, thus fostering customer loyalty and repeat business.

Overall, the invention offers a cutting-edge solution for modernizing the delivery process, combining advanced robotics, automation, and intelligent systems to meet the challenges of contemporary logistics. Its adaptability, efficiency, and focus on safety and sustainability make it a valuable asset for any organization involved in the transportation and delivery of goods.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A method of using a product transport and storage system for delivering at least one container such as with a porch bot, at least one mother bot, and a modern milk truck (MMT) comprising:
receiving an electronic order for a plurality of products;
selecting and collecting said plurality of products;
storing said plurality of products within at least one porch bot;
relocating said porch bot(s) to a delivery address for a delivery of said plurality of products;
including real-time order tracking and customer notifications throughout the process.

2. A method as in claim 1 further comprising an order-to-order comparison to other pending/future orders for a user and at least one geographically proximal user for a delivery path minimized delivery, utilizing an AI-based optimization algorithm.

3. A method as in claim 1 further comprising an ergonomically assistive object retrieval and delivery system comprising:
digitally monitoring said containers, said porch bots, and said mother bots for a direction and/or a movement indicating if mechanical assistance is needed to help a delivery person move said containers, porch bots, and mother bots;
when said mechanical assistance is desired, engaging at least one movement assistance motor, lever, and/or control to enable and/or assist said movement of said containers, porch bots, and mother bots;
and including a user-friendly interface for manual overrides.

4. A method as in claim 1 wherein relocating said porch bot to said delivery address for said products further comprises:
moving said porch bot(s) into an MMT;
lifting and positioning said porch bot(s) for stowage within said MMT by using a railed crane bot;
transporting said porch bot(s) to said delivery address;
unloading said porch bot(s) using said railed crane bot;
transporting said porch bot(s) to a delivery position;
and including an automated alignment system for precise loading and unloading.

5. A method as in claim 1 wherein relocating said porch bot(s) to said delivery address for said products further comprises:
moving said porch bot(s) into said MMT;
lifting and positioning said porch bot(s) for stowage within said MMT using a railed fork bot comprising a base end distal from a distal end having tines of a fork to lift said porch bot(s), wherein said fork extends from a carriage which slides along a rail arm from said base end to said distal end, and said base end is configured to support said railed fork bot vertically from a floor of a truck trailer, and said distal end comprises a rail car interface to connect to a rail car on a roof of said truck trailer to stabilize said rail car as a column;
transporting said porch bot(s) to said delivery address;
unloading said porch bot(s) using said railed fork bot;
transporting said porch bot(s) to a delivery position;
and featuring a safety mechanism to secure the porch bots during transit.

6. A method as in claim 1 wherein relocating said porch bot(s) to said delivery address for said products further comprises:
moving said porch bot(s) into said MMT with a method comprising lifting and positioning said porch bot(s) for stowage within said MMT using said mother bot;
transporting said porch bot(s) to said delivery address;
unloading said porch bot(s) using said mother bot(s);
transporting said porch bot(s) to a delivery position;
and integrating a real-time monitoring system for environmental conditions within the porch bots.

7. A method as in claim 1 wherein transporting said porch bot(s) to a delivery position for a plurality of porch bots to be delivered to said delivery position is a method of transporting said plurality of porch bots together upon at least one mother bot prior to unloading said plurality of porch bots for transport to said delivery position, including a coordinated unloading mechanism for efficient delivery.

8. A method as in claim 1 further comprising a navigation and GPS system and a position streaming system enhanced in over/under layers with at least one of:
a location tracking label (planet codes, cubic codes, etc),
an optical/video systems integration (ultraviolet, infrared, satellite imagery),
a geolocation data integration,
and incorporating predictive analytics for route optimization.

9. A method as in claim 1 further comprising any combination of:
a visual video analysis system integration for bot way-finding,
an infrared video analysis system integration for enhancing said bot way-finding,
an ultraviolet video analysis system integration for enhancing said bot way-finding,
a weather data analysis system integration for enhancing said bot way-finding,
a satellite data analysis system integration for enhancing said bot way-finding,
and integrating machine learning algorithms for continuous improvement of navigation accuracy.

10. A method of using a product transport and storage system comprising:
a plurality of porch bots, one of said plurality of porch bots being a first porch bot,
a railed crane bot comprising a roof rail to be connected to a roof of a truck trailer longitudinally intermediate a front wall and an opposite rear door of said truck trailer, a rail car which runs longitudinally along said roof rail, wherein suspended from said rail car is a winch having a cord with a free end with a hook to lift and position said porch bot,
at least one mother bot comprising a bed having a side to support said porch bots, and an adjustable height lift connected to an opposite side of said bed from said side to support said porch bots, wherein said adjustable height lift is configured to raise, lower, and translate said bed from a surface, wherein at least one porch bot is placeable in said truck trailer to store and transport cases of groceries, said railed crane bot is connected to said roof of said truck trailer to lift and place said porch bot(s) at least within said truck trailer, and said bed of said mother bot is moveable vertically and horizontally to transport said porch bot(s) to and from said truck trailer to a surface on a porch, patio, or landing,
the steps of the method comprising:
receiving an electronic order for a plurality of products,
selecting and collecting said plurality of products then storing said products within said plurality of porch bots,
relocating said plurality of porch bots to a delivery address for said products,
and integrating a quality assurance system to verify product integrity during transport.

11. The method of using a product transport and storage system as in claim 10 wherein relocating said porch bot to a delivery address for said products further comprises:
moving said porch bot into a modern milk truck (MMT),
lifting and positioning said porch bot for stowage within said MMT using said railed crane bot,
transporting said porch bot to said delivery address,
unloading said porch bot using said railed crane bot,
transporting said porch bot to a delivery position,
and featuring an automated temperature control system within the porch bots.

12. The method of using a product transport and storage system as in claim 10 wherein relocating said porch bot to a delivery address for said products further comprises:
moving said porch bot into a modern milk truck (MMT),
lifting and positioning said porch bot for stowage within said MMT using a railed fork bot comprising a base end distal from a distal end, tines of a fork to lift said porch bot wherein said fork extends from a carriage which slides along a rail arm from said base end to a distal end, and said base end is configured to support said railed fork bot vertically from a floor of said truck trailer, and said distal end comprises a rail car interface to connect to a rail car on a roof of said truck trailer to stabilize said rail car as a column,
transporting said porch bot to said delivery address,
unloading said porch bot using said railed fork bot,
transporting said porch bot to a delivery position,
and including a security system to protect the products during transport.

13. The method of using a product transport and storage system as in claim 10 wherein relocating said porch bot to a delivery address for said products further comprises:
moving said porch bot into a modern milk truck (MMT) with a method comprising:
lifting and positioning said porch bot for stowage within said MMT using said mother bot,
transporting said porch bot to said delivery address,
unloading said porch bot using said mother bot,
transporting said porch bot to a delivery position,
and integrating an automated handling system for seamless transition between bots.

14. The method of using a product transport and storage system as in claim 12 wherein transporting said porch bot to a delivery position for a plurality of porch bots to be delivered to said delivery position is a method of transporting said plurality of porch bots together upon said mother bot prior to unloading said plurality of porch bots for transport to said delivery position, featuring an optimized loading and unloading sequence to minimize delivery time.

15. A modern milk truck (MMT) configured for moving a porch bot comprising:
a delivery vehicle,
any combination of:
a porch elevator bot,
a railed crane bot,
a railed fork bot integrated therein,
featuring an integrated control system to manage the operations of the porch elevator bot, railed crane bot, and railed fork bot,
a monitoring system to track the condition and status of the porch bots during transit, and a communication system to relay real-time information to a central control center for coordinated operations.

16. The modern milk truck (MMT) according to claim 15, further comprising a hybrid power system integrating both electric and diesel power sources, wherein the MMT automatically switches between power sources based on route conditions and load requirements to optimize fuel efficiency.

17. The modern milk truck (MMT) according to claim 15, wherein said monitoring system further comprises an environmental control system that adjusts the internal climate of the MMT's cargo area to maintain the temperature and humidity levels required for the specific products being transported, including automated alerts if conditions fall outside pre-set thresholds.

18. The modern milk truck (MMT) according to claim 15, further comprising an advanced suspension system specifically designed to minimize vibrations and shocks during transport, thereby protecting delicate products and ensuring the integrity of the porch bots and their contents.

19. The modern milk truck (MMT) according to claim 15, wherein said integrated control system includes a machine learning module that analyzes historical delivery data to optimize route planning, loading, and unloading processes, continuously improving efficiency and reducing delivery times over repeated use.

20. The modern milk truck (MMT) according to claim 15, further comprising an autonomous driving capability, wherein the MMT can be operated in a semi-autonomous mode for highway driving, with safety and navigation systems designed to maintain lane position, avoid collisions, and automatically adjust speed based on traffic conditions.
